(19) United States
(12) Patent Application Publication
(10) Pub. No.: US 2015/0188350 A1
(43) Pub. Date: Jul. 2, 2015

(54) Power Storage and Supply System

(71) Applicant: Infineon Technologies Austria AG, Villach (AT)

(72) Inventor: Gerald Deboy, Klagenfurt (AT)

(21) Appl. No.: 14/145,371

(22) Filed: Dec. 31, 2013

(51) Int. Cl. H02J 7/00; H02M 5/04; H02M 3/04

(52) U.S. Cl. CPC H02J 7/0073; H02M 3/04; H02M 5/04; H02J 7/345

(57) ABSTRACT

In accordance with an embodiment, a system includes a power supply bus is configured to be coupled to a power source, a first power converter coupled between the power supply bus and a first charge storage device, and a second power converter coupled between the power supply bus and a second charge storage device. In a first operation mode of the system, the first power converter is configured to only operate in one of a charging mode in which it charges the first charge storage device and a discharging mode in which it discharges the first charge storage device, and the second power converter is configured to operate either in a charging mode in which it charges the second charge storage device, or in a discharging mode in which it discharges the second charge storage device.

### TECHNICAL FIELD

Embodiments of the present invention relate to a system, in particular a power storage and supply system.

### BACKGROUND

Power supply systems using sustainable energy sources, such as solar power plants or wind power plants, provide energy widely independent of the power consumer's needs. Thus, there may be excessive energy in times when the energy consumption is low and the energy production is high, and a lack of energy when the energy consumption is high and the energy production is low. For example, solar power plants usually provide a maximum power in the middle of the day when the power consumption in households is relatively low (because electric light is not needed), and supply significantly less power or no power, respectively, in the evening when the power consumption may be high. Thus, one of the main issues in the context of providing electrical energy from sustainable energy sources is the storage of excessive energy.

### SUMMARY OF THE INVENTION

One embodiment relates to a system. The system includes a power supply bus configured to be coupled to a power source, a first power converter coupled between the power supply bus and a first charge storage device, and a second power converter coupled between the power supply bus and a second charge storage device. In a first operation mode of the system the first power converter is configured to only operate in one of a charging mode in which it charges the first charge storage device and a discharging mode in which it discharges the first charge storage device, and the second power converter is configured to operate either in a charging mode in which it charges the second charge storage device, or in a discharging mode in which it discharges the second charge storage device.

Another embodiment relates to a method. The method includes operating in a first operation mode of a system a first power converter coupled to a power supply bus only in one of a charging mode in which it charges a first charge storage device, and a discharging mode in which it discharges the first charge storage device, and operating in the first operation mode a second power converter coupled to the power supply bus either in a charging mode in which it charges the second charge storage device, or in a discharging mode in which it discharges the second charge storage device.

### BRIEF DESCRIPTION OF THE DRAWINGS

Examples are explained below with reference to the drawings. The drawings serve to illustrate certain principles, so that only aspects necessary for understanding these principles are illustrated. The drawings are not to scale. In the drawings, the same reference characters denote like features.

FIG. 1 schematically illustrates the power production of a sustainable energy source and the power consumption during one day;

FIG. 2 illustrates one embodiment of a power storage and supply system that includes a power supply bus, a first power converter and a second power converter;

FIGS. 3A-3C show timing diagrams that illustrate an overall power production, an overall power consumption, and power received/provided by the first power converter and the second power converter;

FIG. 4 shows a state diagram that illustrates one embodiment of operation of the first power converter and the second power converter in a first operation mode;

FIG. 5 illustrates a relationship between a bus reference voltage and a first threshold voltage and a second threshold voltage;

FIG. 6 shows a state diagram that illustrates one embodiment of operation of the first power converter and the second power converter in a second operation mode;

FIG. 7 illustrates a relationship between a bus reference voltage and a third threshold voltage and a fourth threshold voltage;

FIG. 8 shows a state diagram that illustrates one embodiment of operation of the first power converter and the second power converter in a third operation mode;

FIG. 9 illustrates a relationship between a bus reference voltage and a fifth threshold voltage and a sixth threshold voltage;

FIG. 10 illustrates one embodiment of transitions between the first, second and third operation modes;

FIG. 11 illustrates one embodiment of transitions between the first, second and third operation modes;

FIG. 12 illustrates another embodiment of transitions between the first, second and third operation modes;

FIG. 13 is a timing diagram that illustrates one embodiment of operation of the first power converter in a charging mode;

FIG. 14 is a timing diagram that illustrates one embodiment of operation of the first power converter in a discharging mode;

FIG. 15 illustrates one embodiment of a first charge storage device;

FIG. 16 illustrates one embodiment of a second charge storage device;

FIG. 17 illustrates one embodiment of the first power converter;

FIG. 18 illustrates one embodiment of the second power converter;

FIG. 19 illustrates one embodiment of the first power converter;

FIG. 20 illustrates one embodiment of the second power converter;

FIG. 21 illustrates another embodiment of the first power converter;

FIG. 22 illustrates another embodiment of the second power converter;

FIG. 23 illustrates another embodiment of a power supply circuit;

FIG. 24 illustrates one embodiment of a timing scheme for operating the first power converter in the charging and discharging mode;

FIG. 25 illustrates one embodiment of a timing scheme for operating the first power converter in the charging and discharging mode;

FIG. 26 illustrates one embodiment of a timing scheme for operating the first power converter in the charging and discharging mode;

FIG. 27 illustrates one embodiment of a third power converter circuit; and

FIG. 28 illustrates yet another embodiment of a power supply circuit.

In the following detailed description, reference is made to the accompanying drawings. The drawings form a part of the description and by way of illustration show specific embodiments in which the invention may be practiced. It is to be understood that the features of the various embodiments described herein may be combined with each other, unless specifically noted otherwise.

### DETAILED DESCRIPTION OF ILLUSTRATIVE EMBODIMENTS

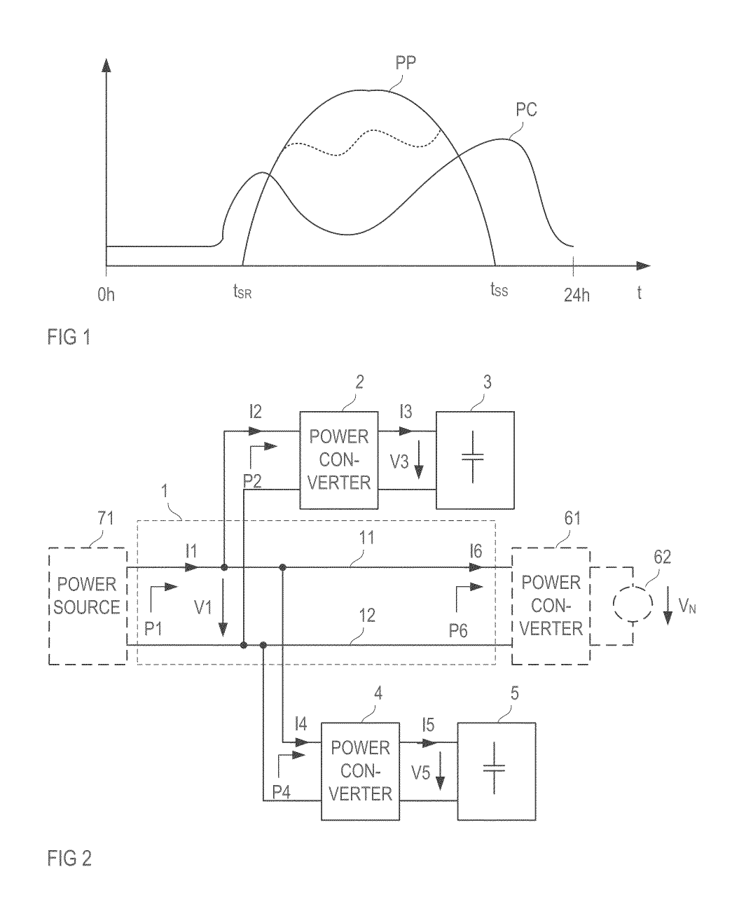

FIG. 1 shows one example of a power production and power consumption scenario. In particular, FIG. 1 shows timing diagrams that illustrate a power PP produced by a sustainable power source during one day (from 0:00 to 24:00), and a power PC consumed by consumers, such as private households, from a power grid. In the embodiment shown in FIG. 1, the sustainable power source is, for example, a solar power plant that is capable of supplying power only between sunrise t_{SR} and sunset t_{SS}. The solid line in FIG. 1 represents a scenario in which there is sunshine from sunrise t_{SR} till sunset t_{SS}. The dotted line represents a scenario in which it is cloudy or partially cloudy; in this scenario the power PP provided by the power source is lower than in the sunshine scenario.

Referring to FIG. 1, in the early morning hours and in the evening hours there are time periods in which power PC is consumed, but there is no power PP produced. Also during the night power PC is consumed, for example, for running refrigerators, air conditions, radiators, or the like. Further, there are time periods, e.g., in the midday hours, in which more power PP is produced by the power source than consumed by the consumers. In order to provide electrical power during those time periods in which the power source does not supply electrical power, and in order to use excess power produced during those times of the day in which the power production is higher than the power consumption, it is desirable to store electrical power (electrical energy).

Electrical energy (which is the time integral of the electrical power) can be stored in charge storage devices. Basically, there are two types of charge storage devices that are different in terms of power density, energy density and the maximum number of possible charging/discharging cycles. The power density defines the ratio between the maximum electrical power the storage device may receive or provide and the volume of the storage device (the unit of the power density is usually given in W/l (watt per liter)). The higher the power density the more power can be provided/received by the storage device at a given volume of the storage device. The energy density defines the ratio between maximum electrical energy the storage device may receive or provide and the volume of the storage device (the unit of the power density is usually given in Wh/l (watt hours per liter)). The higher the energy density the more energy can be stored by the storage device at a given volume of the storage device. The maximum number of charging/discharging cycles defines the number of charging/discharging cycles a storage device may undergo before degradation effects set in that reduce the capacitance and/or the capability to store energy.

Basically, storage devices with a high power density, have a relatively low energy density, and vice versa. For example, double layer capacitors (super capacitors) have a power density of up to 1E5 (10⁵) W/l but a power density of only between 10 Wh/1 and 20 Wh/l, while lithium-ion batteries have a ten time lower power density of only up to 1E4 W/l but a 40 times higher power density of up to 400 Wh/l. Even, lead-acid accumulators have a higher energy density than double layer capacitors. The energy density of lead acid accumulators is up to 90 Wh/l, whereas the maximum power density is only 900 W/l.

Double layer capacitors have a higher maximum number of charging/discharging cycles than lithium-ion batteries or lead acid accumulators. Currently, lead acid accumulators are cheaper than lithium-ion accumulators so that there may be applications where lead acid accumulators are used instead of lithium-ion accumulators, although lead acid accumulators have a lower power density and a lower energy density than lithium-ion accumulators.

A first type of charge storage devices, such as lead acid accumulators, or lithium-ion accumulators, have a relatively high energy density, but cannot be charged/discharged as often as charge storage devices of the second type, such super capacitors (super caps). Further, those charge storage devices of the second type have a higher power density than the first type charge storage devices.

FIG. 2 schematically illustrates one embodiment of a power supply system that includes a first charge storage device 3, and a second charge storage device 5. According to one embodiment, the first charge storage device 3 is a charge storage device of the first type, and the second charge storage device 5 is a charge storage device 5 of the second type. Thus, the system is capable of using the benefits of both types of charge storage devices. In the following, the first charge storage device 3 of the first type will briefly be referred to as first type charge storage device, and the charge storage device 5 of the second type will briefly be referred to as second type charge storage device 5.

Referring to FIG. 2, the system further includes a power supply bus 1 that is configured to receive electrical power P1 from a power source 71 (illustrated in dashed lines in FIG. 2), and to supply electrical power P6 to a load. The load may include a power converter (power inverter) 61 and a power grid 62 coupled to an output of the power converter 61. The power converter 61 may be a conventional power converter that is capable of receiving a DC power from the power supply bus and supplying an AC power to the power grid 62. The power supply bus 1 may include a first supply line 11, and a second supply line 12. A voltage V1 between the first supply line 11 and the second supply line 12 will be referred to as bus voltage V1 in the following. A current I1 received by the power supply bus 1 from the power source 71 will be referred to as input current, and a current I6 provided from the power supply bus 1 to the load will be referred to as output current in the following.

Referring to FIG. 2, a first power converter 2 is coupled between the power supply bus 1 and the first storage device 3. That is, an input of the first power converter 2 is coupled to the power supply bus 1, and an output of the first power converter 2 is coupled to the first storage device 3. A second power converter 4 is coupled between the power supply bus 1 and the second storage device. That is, an input of the second power converter 4 is coupled to the power supply bus 1, and an output of the second power converter 4 is coupled to the second type storage device 5.

In the system shown in FIG. 2, the power supply bus 1 may only receive power from the power source 71 and may only supply power to the load 61, 62. The first power converter 2 may either receive power from the power supply bus 1 in order to charge the first storage device 3, or supply power to the power supply bus 1 in order to discharge the first type storage device 3. An operation mode of the first power converter 2 in which the first power converter 2 charges the first type storage device 3 will be referred to as charging mode in the following, and an operation mode of the first power converter 2 in which the first power converter 2 discharges the first type storage device 3 will be referred to as discharging mode in the following. In the charging mode, a current I2 flows from the power supply bus 1 into the first power converter 2, and a current I3 (charging current) flows from the power converter 2 into the first type storage device 3. In the discharging mode, the current I3 (discharging current) flows in a direction opposite the direction indicated in FIG. 2 from the first type storage device 3 into the power converter 2, and the current I2 flows from the first power converter 2 into the power supply bus 1.

Equivalently, the second power converter 4 may either receive power from the power supply bus 1 in order to charge the second storage device 5, or may supply power to the power supply bus 1 in order to discharge the second storage device 5. An operation mode of the second power converter 4 in which the second power converter 4 charges the second storage device 5 will be referred to as charging mode in the following, and an operation mode of the second power converter 4 in which the second power converter 4 discharges the second type storage device 5 will be referred to as discharging mode in the following. In the charging mode, a current I4 flows in the direction indicated in FIG. 2 from the power supply bus 1 into the second power converter 4, and a current I5 (charging current) flows in the direction indicated in FIG. 2 from the second power converter 4 into the second type storage device 5. In the discharging mode, the current I5 (discharging current) flows in the direction opposite to the direction indicated in FIG. 2 from the second type storage device 5 into the second power converter 4, and the current I4 flows in the direction opposite to the direction indicated in FIG. 2 from the power converter 4 into the power supply bus 1.

In the system shown in FIG. 2,

P1=P2+P4+P6 (1)

where P1 denotes the power P1 received by the power supply bus from the power source 71, and P6 denotes the power supplied from the power supply bus 1 to the load 61, 62. The power P1 is given by the bus voltage V1 multiplied with the input current I1, and the power P6 is given by the bus voltage V1 multiplied with the output current I6. P1 and P6 are positive in equation (1).

Further, in equation (1), P2 denotes the input/output power of the first power converter 2, and P4 denotes the input/output power of the second power converter 4. P2, which is given by the bus voltage V1 multiplied with the current I2, is positive when the first power converter 2 is in the charging mode and receives power from the power supply bus 1, and P2 is negative when the first power converter 2 is in the discharging mode and supplies power to the power supply bus 1. Equivalently, P4, which is given by the bus voltage V1 multiplied with the current I4, is positive when the second power converter 4 is in the charging mode and receives power from the power supply bus 1, and is negative when the second power converter 4 is in the discharging mode and supplies power to the power supply bus 1.

The power P1 received by the power supply bus 1 from the power source 71 may vary during one day in accordance with the produced power PP explained with reference to FIG. 1. The power P6 received by the load 61, 62 may vary during one day in accordance with the power consumption PC explained with reference to FIG. 1. The curves shown in FIG. 1 only serve to illustrate that power production PP and power consumption PC rarely match when a sustainable power source (energy source) is employed. The specific curves for the power production PP and the power consumption PC may vary in different ways dependent on the specific type of power source and the specific type of users (loads). When, for example, the power source includes a wind power plant, power may even be produced during the night, but only in those times in which there is enough wind.

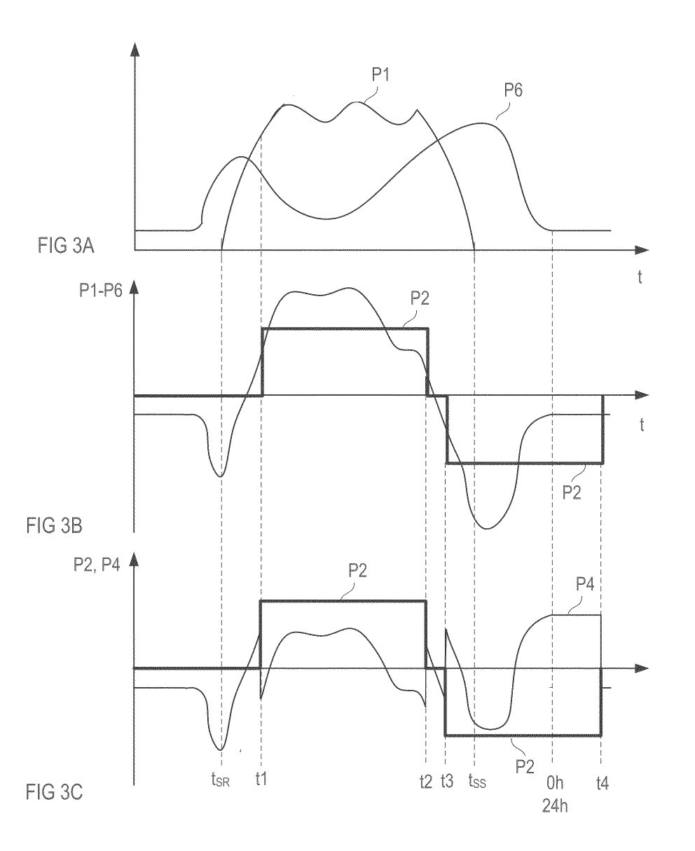

In the system shown in FIG. 2, the first storage device 3 and the second storage device 5 store electrical energy received from the power supply bus in those times in which the power production is higher than the power consumption, and supply energy to the power supply bus 1 in those times in which the power consumption PC is higher than the power production. This is explained with reference to FIGS. 3A-3C below.

FIG. 3A shows timing diagrams of the power P1 received by the power supply bus 1 from the power source during one day, and the power P6 supplied from the power supply bus 1 to the load 61, 62. These powers P1, P2 are defined by external entities, namely the power source 71 that provides the power P1 it can provide, and the load 61, 62 that receives the power it requires.

FIG. 3B illustrates the difference P1−P6 between the power P1 received by the power supply bus 1 from the power source 71 and the power P6 supplied by the power supply bus 1 to the load 61, 62. In the example shown in FIG. 3B, this difference P1−P6 is positive when there is more power received by the power supply bus 1 than supplied by the power supply bus 1, and this difference P1−P6 is negative when the power consumption of the load 61, 62 is higher than power production of the power source 71. In those times in which there is excess power (P1−P6>0) at least one of the first and second storage devices 3, 5 may store energy. Equivalently, in those times in which the power consumption is higher than the power production, at least one of the first and second storage devices 3, 5 may supply energy to the power supply bus 1.

According to one embodiment, the first power converter 2 and the second power converter 4 operate the first storage device 3 and the second storage device 5 such that the first storage device 3 has less charging/discharging cycles than the second storage device 5. In this context, “charging cycle” denotes a time period in which the respective storage device is charged, and “discharging cycle” denotes a time period in which the respective storage device is discharged. According to one embodiment, the first and the second power converters 2, 4 operate the first and second storage devices 3, 5 such that the first storage device 3 has a maximum of five charging/discharging cycles (ten overall cycles, wherein one cycle is either a charging or a discharging cycle), three charging/discharging cycles (six overall cycles), a maximum of two charging/discharging cycles (four overall cycles), or even a maximum of one charging/discharging cycles (two overall cycles) in 24 hours.

FIG. 3C shows timing diagrams that illustrate one embodiment in which the first type storage device 3 has only one charging cycle (between a first time t1 and the second time t2) and only one discharging cycle (between a third time t3 and a fourth time t4) in 24 hours. In particular, FIG. 3C shows timing diagrams of the power P2 received by the first power converter 2 from the power supply bus 1 and used to charge the first type storage device 3, or supplied by the first power converter 2 to the power supply bus 1 and received from the first storage device. In the embodiment shown in FIG. 3C, this power P2 is positive when the power converter 2 receives power from the power supply bus 1, and the power P2 is negative when the second power converter 2 supplies power to the power supply bus 1. FIG. 3C further shows the power P4 received by the second power converter 4 from the power supply bus 1 and used to charge the second type storage device 5, or supplied by the second power converter 4 to the power supply bus 1 and received from the second storage device 5. In the embodiment shown in FIG. 3C, this power P4 is positive when the second power converter 4 receives power from the power supply bus 1, and this power P4 is negative when the second power converter 4 supplies power to the power supply bus 1.

In the embodiment shown in FIG. 3C, the power P2 received by the second power converter 2 in the charging cycle is drawn to be substantially constant, and the power P2 supplied by the second power converter 2 to the power supply bus in the discharging cycle is drawn to be substantially constant. However, this is only an example and is only for the purpose of explanation. The power consumption of the second power converter 2 in the charging cycle may vary dependent on the specific type of first type storage device 3 and on the charging characteristic. Equivalently, the power P2 supplied by the second power converter 2 to the power supply bus 1 in the discharging cycle may vary dependent on the specific type of first type storage device 3 and on a desired discharging characteristic.

Referring to FIG. 3C, the second storage device 5 has several charging/discharging cycles in 24 hours. During those time periods in which the first storage device 3 is neither charged nor discharged, so that P2=0, the second storage device 5 is charged when there is excess power (P1−P6>0) and is discharged when the power consumption is higher than the power production (P1−P6<0). In those time periods, in which P2=0,

P4=P1−P6 (2).

That is, the second power converter 4 balances the difference P1−P6. In the charging cycle of the first storage device 3, the second storage device 5 is charged when P1−P6>P2, and is discharged when P1−P6<P2. That is, there may be time periods in which the second storage device 5 is discharged on account of the first storage device 1. In the discharging cycle of the first storage device 3, the second type storage device 5 is charged, when |P6−P1|<|P2|. The system shown in FIG. 2 may us the benefits of both types of storage devices, namely the high power density of the first storage device 1, and the capability of the second storage device to withstand a plurality of charging/discharging cycles without significant degradation.

Embodiments of how the first converter 2 and the second converter 4 may control charging/discharging of the first type storage device 3 and the second type storage device 5 are explained below.

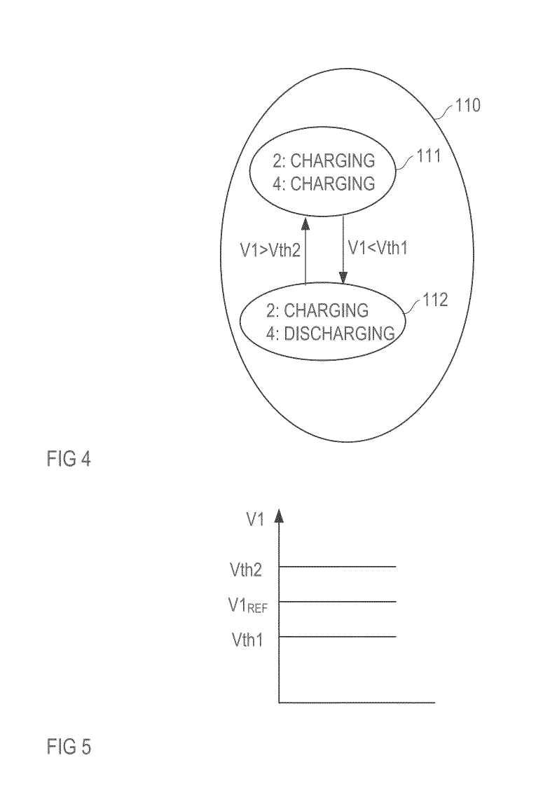

FIG. 4 shows one embodiment of a state diagram of the system shown in FIG. 2.

FIG. 5 illustrates a first operation mode 110 of the system. This first operation mode 110 corresponds to a charging cycle of the first storage device 3. That is, the first type storage device 3 is permanently charged in the first operation mode 110. In the first operation mode 110, the second storage device 4 may either be charged or discharged as explained herein above. Thus, the first operation mode 110 may include two different operation modes (sub-modes) 111, 112. In the operation mode 111, the first power converter 2 and the second power converter 4 are in a charging mode so as to charge both the first type storage device 3 and the second type storage device 5. In an operation mode 112, the first power converter 2 is in a charging mode so as to charge the first type storage device 3, and the second power converter 4 is in a discharging mode so as to discharge the second type storage device 5. Alternatively, the first type storage device 3 may permanently be discharged in the first operation mode 110.

According to one embodiment, in the first operation mode 110, the system switches between the operation mode 111 and the operation mode 112 dependent on a voltage level of the bus voltage V1. According to one embodiment, in the first operation mode 110, the second power converter 4 controls the power P4 received by the second power converter 4 or supplied by the second power converter 4 such that a voltage level of the bus voltage V1 is substantially constant and equals a reference voltage level V1_{REF}. According to one embodiment, the reference voltage level is selected from a range of between 380V and 480V. This reference voltage level may be dependent on the type of load connected to the power supply bus. According to one embodiment, the load includes a power grid and the reference voltage level V1_{REF} is higher than a maximum voltage level of the grid voltage V_{N}.

If in the operation mode 111, in which both the first power converter 2 and the second power converter 4 are charging the respective storage device 3, 5, the power P2 received by the second power converter 2 is higher than the power available on the power supply bus 1, the second power converter 4 cannot regulate the bus voltage V1 by charging the second type storage device any more. In this case, the bus voltage V1 inevitably falls below the reference voltage V1_{REF}. According to one embodiment, the second power converter 2 switches from the charging to the discharging mode, so that the system switches from operation mode 111 to operation mode 112, when a voltage level of the bus voltage V1 falls below a first threshold voltage Vth1 that is below the first reference voltage V1_{REF} (Vth1<V1_{REF}). If the second power converter 4 is in the discharging mode and the power available on the power supply bus becomes higher than the power P2 received by the first power converter 2, than the second power converter 4 cannot regulate the bus voltage V1 by discharging the second type storage device 5. In this case, the voltage of the bus voltage V1 inevitably increases above the reference voltage V1_{REF}. According to one embodiment, the second power converter 3 switches from the discharging mode to the charging mode, so that the system switches from the operation mode 112 to the operation mode 111, when the voltage level of the bus voltage V1 increases above a second threshold voltage Vth2 that is higher than the reference voltage V1_{REF}. Embodiments of the voltage levels of the reference voltage V1_{REF} and the first and the second threshold voltages Vth1, Vth2 are illustrated in FIG. 5.

Referring to FIG. 4, a decision of the second power converter 4 to switch from the charging mode to the discharging mode or from the discharging mode to the charging mode is based on the voltage level of the bus voltage V1. According to one embodiment, only an instant voltage level of the bus voltage V1 is considered in this decision. According to another embodiment, the voltage level of the bus voltage V1 is filtered and the decision to switch between the charging mode and the discharging mode is based on a filtered signal obtained by filtering the voltage level of the bus voltage V1. According to one embodiment, this filter has an I-characteristic or a PI-characteristic. Using the filtered bus voltage V1 instead of directly using the bus voltage V1 may help to prevent voltage spikes of the bus voltage V1 from erroneously causing the second power converter 3 to switch between the charging mode and the discharging mode.

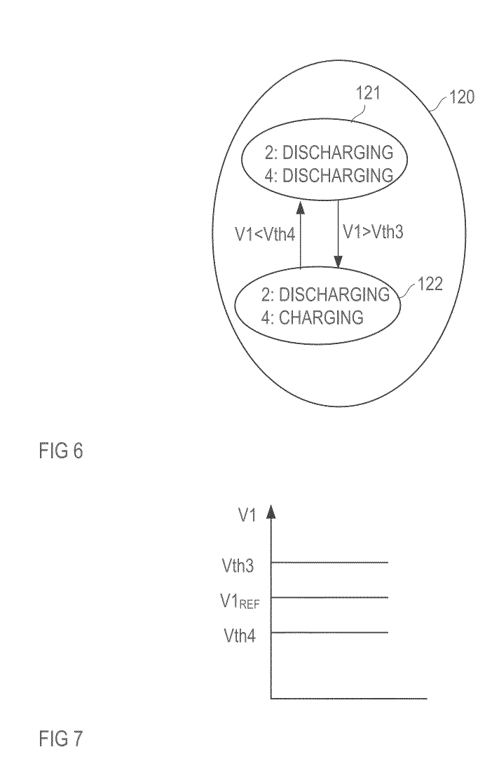

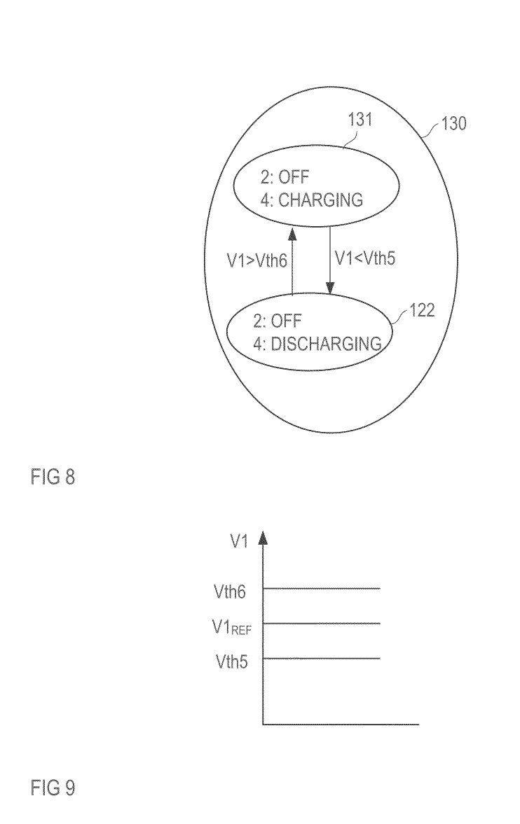

FIG. 6 illustrates one embodiment of operation of the system in a second operation mode 120. This second operation mode 120 corresponds to a discharging cycle of the first type storage device 3. That is, the first type storage device 3 is permanently discharged in the second operation mode 120. In this second operation mode 120, the second power converter 4 is either in the discharging mode so as to discharge the second type storage device 5 and to supply power to the power supply bus, or in the charging mode so as to receive power from the power supply bus and charge the second type storage device 5. Thus, there are two different operation modes (sub-modes) in the second operation mode 120. In an operation mode 121 shown in FIG. 6, both the first power converter 2 and the second power converter 4 are in the discharging mode. In an operation mode 122, the first power converter 2 is in a discharging mode and the second power converter 4 is in the charging mode.

According to one embodiment, in the second operation 120, the second power converter 4 is configured to control the voltage level of the bus voltage V1 to be substantially constant and to equal a reference voltage V1_{REF} by either charging or discharging the second storage device 5. According to one embodiment, the second power converter 4 switches between the discharging mode and the charging mode dependent on a voltage level of the bus voltage V1. Referring to FIG. 6, the second power converter 4 may switch from the discharging mode to the charging mode when the voltage level of the bus voltage V1 increases above a third threshold voltage Vth3 that is higher than the reference voltage V1_{REF}. The voltage level of the bus voltage V1 may increase to the third threshold voltage Vth3 when both the first power converter 2 and the second power converter 4 supply power to the power supply bus 1, but the power required on the power supply bus 1 is lower than the power P2 provided by the first power converter 2. In this case, the second converter 4 switches to the charging mode in order to receive excess power from the power supply bus 1. Equivalently, the power converter 4 may switch from the charging mode to the discharging mode when the voltage level of the bus voltage V1 falls below a fourth threshold voltage Vth4. The bus voltage V1 may fall below the fourth threshold voltage Vth4 when the power required on the power supply bus 1 is higher than the power P2 provided by the second power converter 2. Embodiments of the voltage levels of the reference voltage V1_{REF} and the third and the fourth threshold voltages Vth3, Vth4 are illustrated in FIG. 7.

According to one embodiment, the third threshold voltage Vth3 corresponds to the second threshold voltage Vth2 (Vth2=Vth3) and the fourth threshold voltage Vth4 corresponds to the first threshold voltage Vth1 (Vth1=Vth4).

Referring to FIG. 8, the system may further be operated in a third operation mode 130 in which the second power converter 2 is deactivated (off) and the second power converter 4 is either in the charging mode or the discharging mode. In this third operation mode 130, the second power converter 2 neither receives nor supplies power to the power supply bus 1. In this operation mode 130, the second power converter 4 may regulate the voltage level of the bus voltage V1_{REF} by either charging or discharging the second type storage device 5. Thus, there are two different operation modes (sub-modes) in the second operation mode. In an operation mode 131 the second power converter 4 is in the charging mode, and in an operation mode 132 the second power converter 4 is in the discharging mode. Like in the first operation mode 110 and the second operation mode 120 the second power converter 4 may switch between the charging mode and the discharging mode dependent on the voltage level of the bus voltage V1. According to one embodiment, the second power converter 4 changes from the charging mode to the discharging mode when the voltage level of the bus voltage V1 falls below a fifth threshold voltage Vth5 which is below the reference voltage V1_{REF}. The voltage level of the bus voltage V1 may fall below this fifth threshold voltage Vth5 in the third operation mode 130 when the power P6 received by the load 61, 62 becomes higher than the power P1 supplied by the power source 71. The second power converter 4 may switch from the discharging mode to the charging mode when the voltage level of the bus voltage V1 increases above a sixth threshold voltage Vth6 which is higher than the reference voltage V1_{REF}. The bus voltage V1 may increase above the sixth threshold voltage Vth6 when the power P1 generated by the power source 71 is higher than the power P6 received by the load 61, 62.

The system may switch between the first operation mode 110, the second operation mode 120, and the third operation mode 130 in different ways. According to one embodiment, the system enters these operation modes 110, 120, 130 based on the time. That is, the system may enter the first operation mode 110 at a pre-defined time and may leave the first operation mode 110 at pre-defined time, and the system may enter the second operation mode 120 at a pre-defined time and may leave the second operation mode 120 at pre-defined time. For example, these times may be selected dependent on the time of sunrise and sunset.

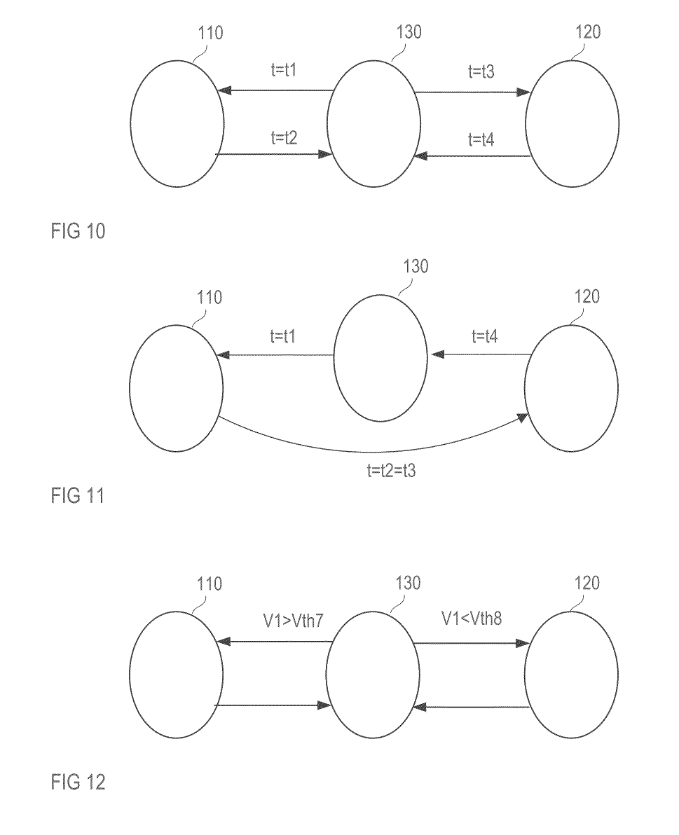

FIG. 10 shows a state diagram that illustrates a time-based operation of the system. Referring to FIG. 10, the system enters the first operation mode 110 at a first time t1 (see also FIGS. 3A-3C) and leaves the first operation mode 110 at a second time t2. Further, the system enters the second operation mode 120 at a third time t3 and leaves the second operation mode 120 at a fourth time t4. In this embodiment, the system assumes the third operation mode 130 between the first and the second operation modes 110, 120.

According to another embodiment, shown in FIG. 11, a second time t2 corresponds to the third time t3, so that the system directly switches from the first operation mode 110 in which the second power converter 2 charges the first storage device 3 to the second operation mode 120 in which the second power converter 2 discharges the first storage device 3.

According to a further embodiment, shown in FIG. 12, the second power converter 2 enters at least one of the charging mode and the discharging mode dependent on the voltage level of the bus voltage V1. According to one embodiment, the first power converter 2 enters the charging mode, which is equivalent to the system entering the first operation mode 110, when a voltage level of the bus voltage V1 increases to a seventh threshold voltage Vth7. According to one embodiment, this seventh threshold voltage Vth7 is higher than the second threshold voltage Vth2, the third threshold voltage Vth3 and the sixth threshold voltage Vth6. The bus voltage V1 may reach the seventh threshold Vth7 when the power source 71 supplies more power P1 than the load 61, 62 and the second power converter 5 together may draw from the power supply bus 1. Equivalently, the first power converter 2 may enter the discharging mode, when the voltage level of the bus voltage V1 falls below an eighth threshold voltage Vth8. This eighth threshold Vth8 is below the first threshold Vth1, the fourth threshold voltage Vth4, and the fifth threshold voltage Vth5 explained below. The bus voltage V1 may fall below this eighth threshold Vth8 when the load 61, 62 draws more power from the power supply bus 1 than the power source 71 and the second power converter 5 together may supply.

According to one embodiment, the system stays in the first operation mode 110 for a pre-defined time period. That is, the first type storage device 3 is charged for a pre-defined time period. Alternatively, the system stays in the first operation mode 110 until the voltage V3 across the first type storage device 3 has reached a pre-defined threshold. Equivalently, the system may stay in the second operation mode 120 for a pre-defined time period, or may stay in the second operation mode 120 until the voltage V3 across the first type storage device 3 has fallen to or below a pre-defined threshold.

Besides the time and the bus voltage V1, other parameters may be used in the decision to enter one of the first and second modes 110, 120.

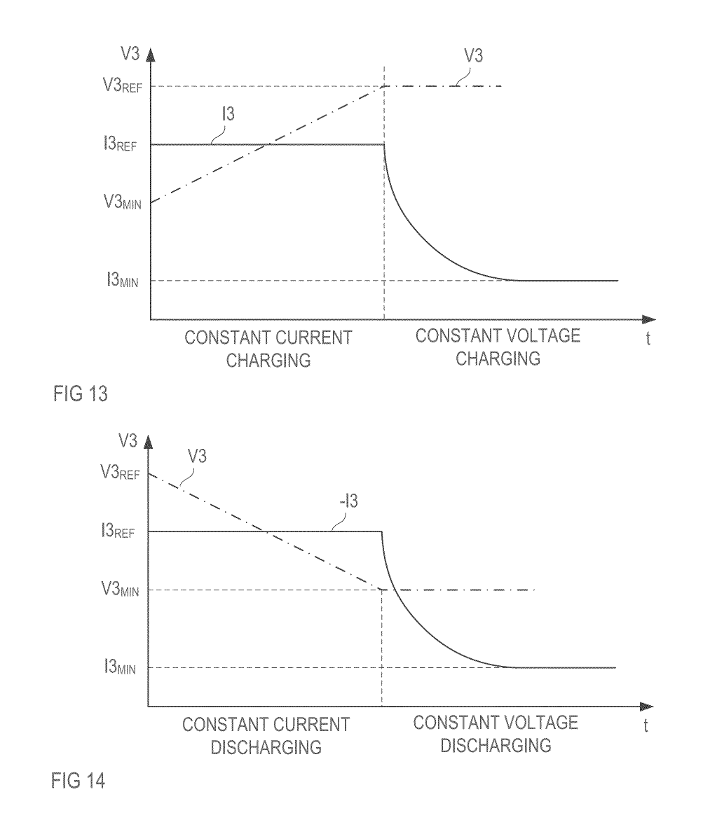

One way of operation of the first power converter 2 in the charging mode is explained with reference to FIG. 13 below. Referring to FIG. 13, the first power converter 2 may charge the first type storage device 3 either in a constant current charging mode, or a constant voltage charging mode. In the constant current charging mode, the first power converter 2 supplies a substantially constant current I3 to the first storage device 3. This charging current I3 may cause the voltage V3 across the first type storage device 3 to increase. Referring to FIG. 13, the first power converter 3 may enter the constant voltage charging mode when the voltage V3 reaches a reference voltage level V3_{REF}. In this constant voltage charging mode, the first power converter 2 substantially keeps the voltage V3 constant, which may cause the charging current I3 to decrease. In the constant current charging mode, a current level of the charging current I3 substantially corresponds to a reference current level I3_{REF}, while the voltage V3 may vary. In the constant voltage charging mode, the voltage level of the voltage V3 substantially corresponds to the reference voltage level V3_{REF}, while the charging current I3 may vary. According to one embodiment, the first power converter 3 stops charging the first storage device 3 when the current level of the charging current I3 decreases to a minimum current level I3_{MIN}.

Referring to FIG. 14, in the discharging mode, the first power converter 2 may either operate in a constant current discharging mode, or a constant voltage discharging mode. In the constant current discharging mode, the first power converter 2 discharges the first type storage device 3 such that a voltage level of the discharging current (−I3) substantially corresponds to a reference current level I3_{REF}. This reference current level I3_{REF} in a constant current discharging mode may correspond to the reference current level in the constant current charging mode, or may be different. In the constant voltage discharging mode, the first power converter 2 discharges the first type storage device 3 such that the voltage level of the voltage V3 substantially remains on a pre-defined voltage level V3_{MIN}. Referring to FIG. 14, in the constant current discharging mode, the current level of the discharging current is substantially constant, while the voltage level of the storage device voltage V3 may vary. In the constant voltage discharging mode, the voltage level of the storage device voltage V3 is substantially constant, while the discharging current may vary. According to one embodiment, the first power converter 2 stops discharging the first storage device 3 when the current level of the discharging current has reached a pre-defined minimum current level.

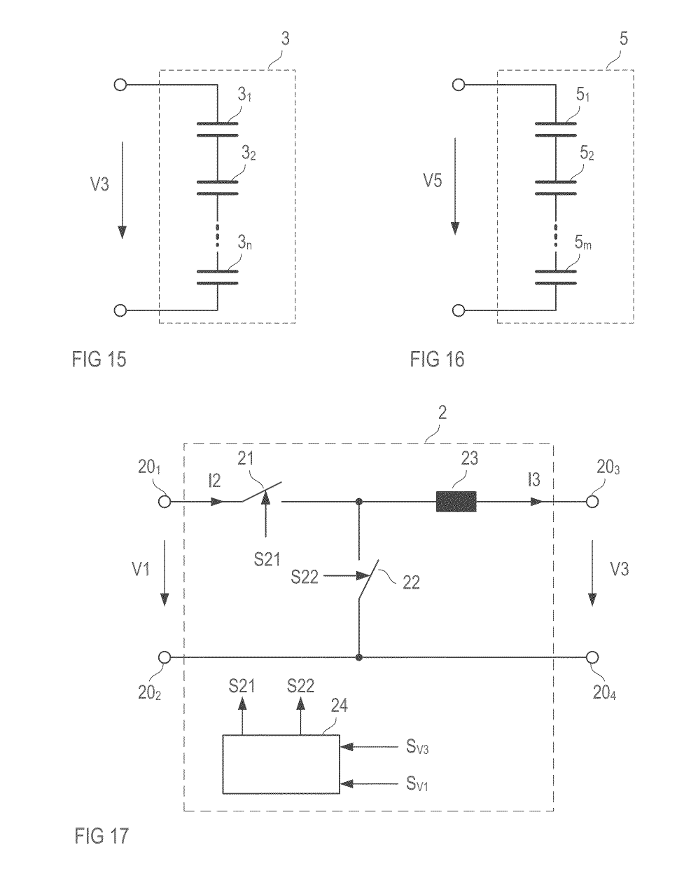

Referring to FIG. 15, the first type storage device 3 may include a plurality of storage cells 3₁, 3₂, 3ₙ connected in series, with the series circuit with the individual storage cells 3₁-3ₙ being coupled to the input of the first type storage device 3. Equivalently, referring to FIG. 16, the second type storage device 5 may include a plurality of storage cells 5₁, 5₂, 5ₙ connected in series.

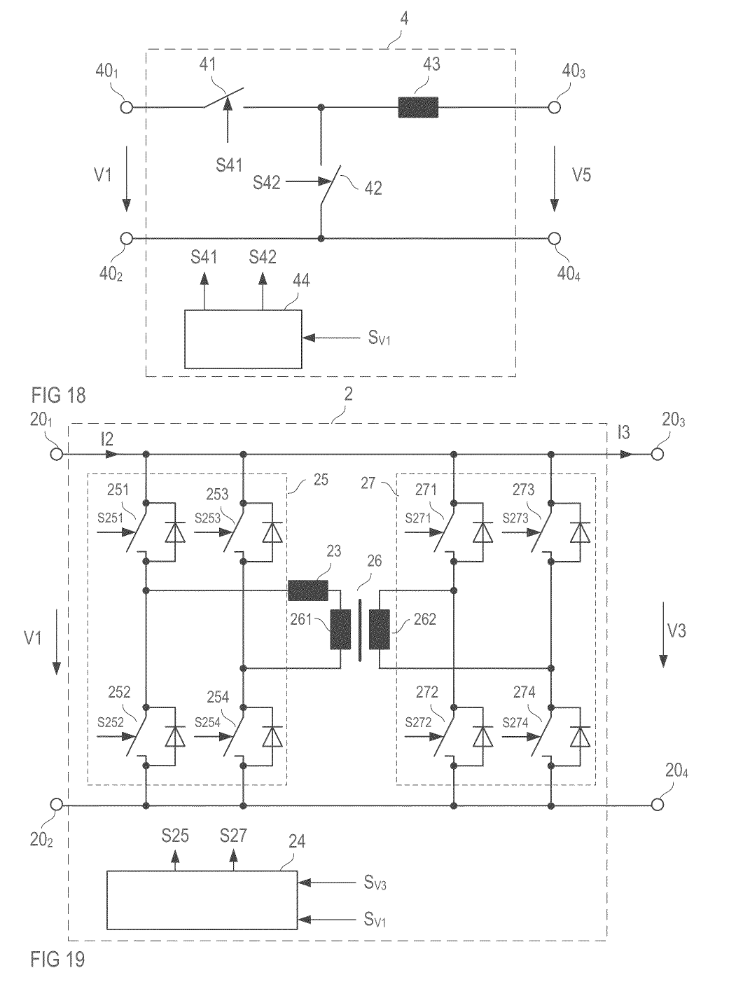

The first power converter 2 and the second power converter 4 can each be implemented with a conventional power converter topology, in particular a DC/DC power converter topology, as well known in the art. For the purpose of explanation and without restricting embodiments of the power supply circuit to a first power converter 2 and a second power converter 4 with a specific power converter topology, FIGS. 17 and 18 each show one embodiment of the first power converter 2, and the second power converter 4, respectively. The power converter in FIG. 16 is implemented as a switched-mode power converter with a buck converter topology. The power converter 2 has an input 20₁, 20₂ configured to be coupled to the power supply bus 1, and an output 20₃, 20₄ configured to be coupled to the first storage device 3. This power converter includes a first switch 21 and a second switch 22 that are connected in series, wherein the series circuit with the first switch 21 and the second switch 22 is coupled between a first input node 20₁ and a second input node 20₂. An inductive storage element 23, such a choke, is coupled between a tap of the switch series circuit and a first output node 20₃. A second output node 20₄ corresponds to the second input node 20₂ in this embodiment.

In the charging mode, the power converter 2 shown in FIG. 17 operates as a buck converter, and in the discharging mode, the power converter 2 operates as a boost converter. In each of these operation modes, a PWM-(pulse-width modulation)-controller 24 controls the first switch 21 and the second switch 22 in a pulse-width modulated (PWM) fashion. The PWM-controller 24 receives a voltage signal S_{V3} that is representative of the storage device voltage V3 at the output 20₃, 20₄, and a current signal S_{I3} that is representative of the current I3 at the output 20₃, 20₄. Referring to the explanation provided in context with FIGS. 12 and 13, the PWM-controller 24 in the charging mode and in the discharging mode may either control the current I3 at the output 20₃, 20₄ or the storage device voltage V3. In the charging mode, the current I3 flows in the direction as indicated in FIG. 16, in the discharging mode, the current I3 flows in the opposite direction.

Each of the current I3 and the voltage V3 can be controlled by suitably adjusting duty cycles of first and second drive signals S21, S22 that drive the first switch 21 and the second switch 22, respectively. Driving the first and the second switches 21, 22 includes a plurality of timely subsequent drive cycles. In the charging mode, in each drive cycle, the PWM-controller 24 switches on the first switch 21 for an on-period while the second switch 22 is off. In this on-period, electrical energy is inductively stored in the storage element 23. At the end of the on-period, the first switch 21 switches off and the second switch 22 switches on. In this time period the second switch 22 acts a free-wheeling element that enables the energy previously stored in the storage element 23 to be transferred to the output 20₃, 20₄ and the first storage device 3 coupled thereto. Each drive cycle may last for a pre-defined time period. The current I3 and the voltage V3 can be controlled (regulated) by adjusting the duty cycle of the first switch 21. The duty cycle is given by the relationship between the duration of the on-period and the duration of one drive cycle.

In the discharging mode, the power converter 2 acts as a boost converter. In this operation mode, the PWM-controller 24, in each drive cycle, switches on the second switch 22 for an on-period while the first switch 21 is off. In this on-period, electrical energy is inductively stored in the storage element 23. At the end of the on-period, the second switch 22 switches off and the first switch 21 is switched on. In this time period, the energy previously stored in the storage element 23 is transferred to the input 20₁, 20₂ and the power supply bus 1, respectively. In this operation mode, either the current I3 or the voltage V3 is controlled by the PWM-controller 24 by suitably controlling the duty cycle of the second switch 22.

In each drive cycle in the discharging mode, the first switch 21 switches off when or before the second switch 22 switches on. Equivalently, in the charging mode, the second switch 22 switches off at the end of each drive cycle, that is before the first switch 21 is switched on again.

FIG. 18 illustrates one embodiment of the second power converter 4. In this embodiment, the second power converter 4 is implemented with a buck converter topology and, like the first power converter 2 explained with reference to FIG. 16, includes a first switch 41 and a second switch 42 coupled to an input 40₁, 40₂ with a first input node 40₁ and a second input node 40₂, and an inductive storage element 43 coupled between a tap of the switch series circuit and a first output node 40₃. A second output node 40₄ corresponds to a second input node 40₂. The series circuit with the first switch 41 and the second switch 42 is coupled between the first input node 40₁ and the second input node 40₂.

A PWM-controller 44 controls operation of the first switch 41 and the second switch 42 dependent on a bus voltage signal S_{V1}. This bus voltage signal S_{V1} is representative of the bus voltage V1. In the charging mode, that is when the power converter 4 transfers power from the input 40₁, 40₂ to the output 40₃, 40₄, the PWM-controller 44 controls the duty cycle of the first switch 41 dependent on the bus voltage signal Sᵥᵢ such that the voltage level of the bus voltage V1 corresponds to the reference voltage level V1_{REF} explained before. In the discharging mode, that is when the second power converter 4 transfers power from the output 40₃, 40₄ (from the second storage device 5) to the input 40₁, 40₂, the PWM-controller 44 controls the duty cycle of the second switch 42 such that the voltage level of the bus voltage V1 corresponds to the reference voltage level V1_{REF} explained herein before. In the way explained before, the PWM-controller 44 dependent on the bus voltage V1 may switch between the charging mode and the discharging mode.

Further, the first power converter 2 and the second power converter 4 may provide for a galvanic isolation between the power supply bus 1 and the first and second charge storage device 3, 5, respectively. Such galvanic isolation may be useful in a power supply circuit in which the bus voltage V1 is significantly higher, such as more than 3 times, more than 5 times, or even more than 10 times higher than one of the voltages V3 and V5 of the first charge storage device 3 and the second charge storage device 5, respectively.

In this case, the first power converter 2 and the second power converter 4 each include a transformer or other means for galvanically isolating the power supply bus 1 and the first and second charge storage device 3, 5, respectively. In this case, each of the first power converter 2 and the second power converter 4 can be implemented with a topology as disclosed in FIGS. 2a and 2b of Everts, J.; Krismer, F.; Van den Keybus, J.; Driesen, J.; Kolar, J. W., “Comparative evaluation of soft-switching, bidirectional, isolated AC/DC converter topologies,” 27^{th} Annual IEEE Applied Power Electronics Conference and Exposition (APEC), Feb. 5-9, 2012, pp. 1067-1074, which is disclosed herein by reference in its entirety. That is, each of the first power converter 2 and the second power converter 4 can be implemented with a dual active bridge (DAB) topology as shown in FIGS. 2a and 2b of Everts, et al.

One embodiment of a first power converter 2 implemented with a full bridge-full bridge DAB topology as disclosed in Everts is illustrated in FIG. 19. It should be noted that the power converter topology shown in FIG. 19 is only an example. Other bidirectional power converter topologies providing for a galvanic isolation, in particular other DC/DC power converter topologies, may be used as well.

Referring to FIG. 19, the first power converter 2 includes a first (full) bridge circuit 25 with two half bridges each including a high-side switch 251, 253 and a low-side switch 252, 254. The bridge circuit 25 is connected between the input nodes 20₁, 20₂ for receiving the supply voltage V1. A series circuit with an inductive storage element 23 and a primary winding 261 of a transformer 26 is connected between output nodes of the two half bridges. An output node is a circuit node common to the high-side switch 251, 253 and the low-side switch 252, 254 of one half-bridge. The transformer 26 provides for the galvanic isolation between the input 20₁, 20₂ and the output 20₃, 20₄ of the first power converter 2 and includes a secondary winding 262 that is inductively coupled with the primary winding 261. A second bridge circuit 27 with two half bridges each including a high-side switch 271, 273 and a low-side switch 272, 274 is coupled between the secondary winding 262 and the output nodes 20₃, 20₄. Each of these half-bridges includes an input, which is a circuit node common to the high-side switch 271, 273 and the low-side switch 272, 274 of one half-bridge. The input of a first half-bridge 271, 272 is connected to a first terminal of the secondary winding 262, and the input of a second half-bridge 273, 274 is connected to a second terminal of the secondary winding 262. The series circuits with the high-side switch 271, 273 and the corresponding low-side switch 272, 274 are connected between the output nodes 20₃, 20₄.

The switches 251-254, 271-274 of the bridge circuits 25, 27 shown in FIG. 19 may be implemented to include a rectifier element (freewheeling element), such as a diode, connected in parallel with the switch. These switches can be implemented as conventional electronic switches, such as MOSFETs (Metal-Oxide Field-Effect Transistors), IGBTs (Insulated Gate Bipolar Transistors), JFETs (Junction Field-Effect Transistors, HEMTs (High-Electron-Mobility Transistors), or the like. When the switches 251-274 are implemented as MOSFETs, an internal body diode of the MOSFETs can be used as rectifier element, so that no additional rectifier element is required.

Referring to FIG. 19, a control circuit 24 controls operation of the two bridge circuits 25, 27. For this, each of the switches receives an individual drive signal from the control circuit 24. These drive signals are referred to as S251-S254 and S271-S274 in FIG. 19. In FIG. 19, S25 denotes the plurality of drive signals provided by the control circuit 24 to control the first bridge circuit 25, and S27 denotes the plurality of drive signals provided by the control circuit 24 to control the second bridge circuit 27.

According to one embodiment, a timing of switching on and switching off the individual switches 251-254 of the first bridge circuit 25 is such that at least some of the switches 251-254 are switched on and/or switched off when the voltage across the respective switch is zero. This is known as zero voltage switching (ZVS).

The first power converter 2 shown in FIG. 19 can be operated bidirectionally. That is, the power converter 2 can be operated to supply power from the power supply bus 1 to the first charge storage device 3, or to supply power from the first charge storage device 3 to the power supply bus 1.

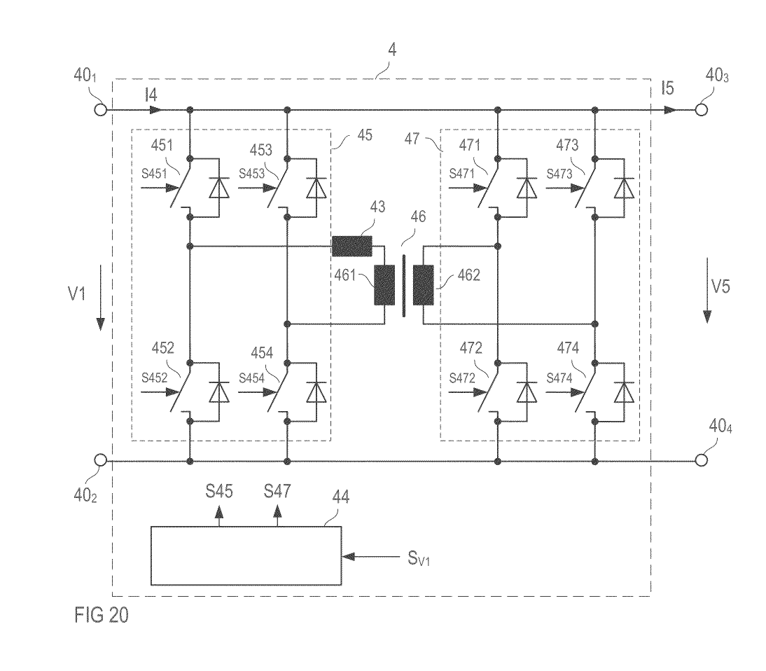

FIG. 20 shows one embodiment of a second power converter 4 implemented with a full bridge-full bridge DAB topology that corresponds to the topology of the first power converter 2 explained with reference to FIG. 19. Like the first power converter 2 explained with reference to FIG. 19, the second power converter 4 includes a first bridge circuit 45 with two half-bridges each including a high-side switch 451, 453 and a low-side switch 452, 454, and a second bridge circuit 47 with two half-bridges each including a high-side switch 471, 473 and a low-side switch 472, 474. A series circuit with an inductive storage element, such as a choke, and a primary winding 461 of a transformer 46 is coupled between outputs of the half-bridges of the first bridge circuit 45, and a secondary winding 462 of the transformer 46 is coupled between outputs (inputs) of the half-bridges of the second bridge circuit 47. The half-bridges of the first bridge circuit 45 are connected between the input nodes 40₁, 40₂ of the second power converter 4, and the half-bridges of the second bridge circuit 47 are connected between the output nodes 40₃, 40₄ of the second power converter 4. Like the first power converter 2 explained with reference to FIG. 19, the second power converter 4 explained with reference to FIG. 20 can be operated bidirectionally.

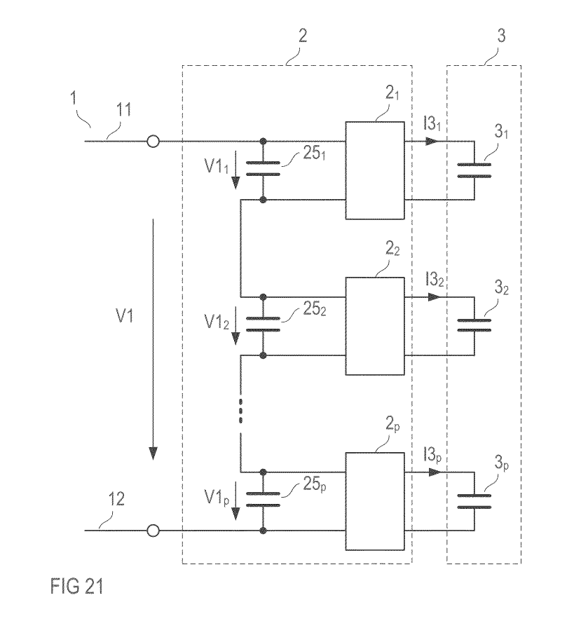

FIG. 21 illustrates another embodiment of the first power converter 2 and the first storage device 3 coupled thereto. In this embodiment, the first power converter 2 includes a plurality of converter stages 2₁, 2₂, 2ₚ, wherein each of these converter stages 2₁, 2₂, 2ₚ has one storage cell 3₁, 3₂, 3ₚ coupled thereto. Each of the storage cells 3₁-3ₚ illustrated in FIG. 18 may include a plurality of sub-cells connected in series or connected in parallel. Each of the converter stages 2₁-2ₚ shown in FIG. 18 may be implemented with a buck converter topology explained with reference to FIG. 17. Additionally, each of these converter stages 2₁-2ₚ includes an input capacitors 25₁-25ₚ coupled to the input of the converter stage. The individual converter stages 2₁-2ₚ are cascaded. That is, the individual capacitors 25₁-25ₚ are connected in series, wherein the series circuit with the individual input capacitors 25₁-25ₚ is coupled to the power supply bus 1. In this arrangement with the first power converter 2 and the first type storage device 3, each of the converter stages 2₁, 2₂, 2ₚ may charge the respective storage cell 3₁-3ₚ autonomously in the charging mode. In the discharging mode, one of the plurality of converter stages may act as a master stage that defines the discharging current of the respective storage cell. The other converter stages discharge the corresponding storage cell in accordance with the discharging current defined by the master converter stage.

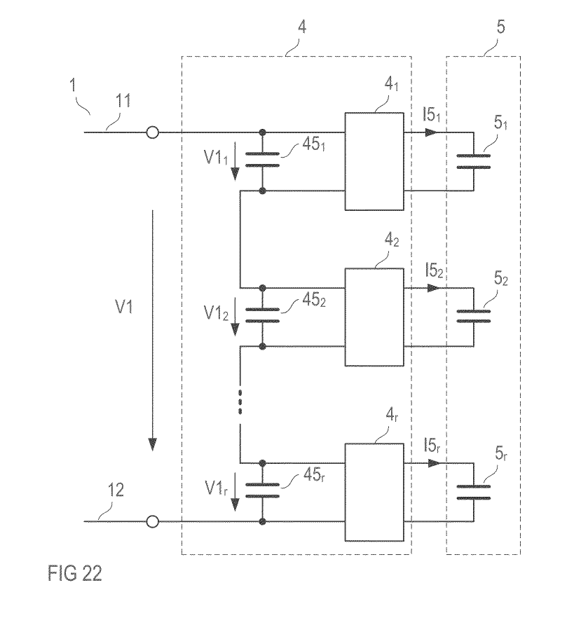

FIG. 22 shows a further embodiment of the second power converter 4 and the second type storage device 5 coupled thereto. Like the first power converter 2 shown in FIG. 21, the second power converter 4 shown in FIG. 20 includes a plurality of converter stages 4₁, 4₂, 4ᵣ each having one storage cell 5₁, 5₂, 5ᵣ of the second storage device 5 coupled thereto. The individual converter stages 4₁-4ᵣ may be implemented with a buck converter topology explained with reference to FIG. 17. Additionally, each converter stage 4₁-4ᵣ includes an input capacitor 45₁, 45₂, 45ᵣ. The individual input capacitors 45₁-45ᵣ are connected in series. The series circuit with the input capacitors 45₁-45ᵣ is coupled to the power supply bus 1. In this second power converter 4, one of the plurality of converter stages may act as a master stage that defines the charging/discharging current of the respective storage cell dependent on the bus voltage V1 in order to control (regulate) the bus voltage V1. The other converter stages charge/discharge the corresponding storage cell in accordance with the charging/discharging current defined by the master converter stage.

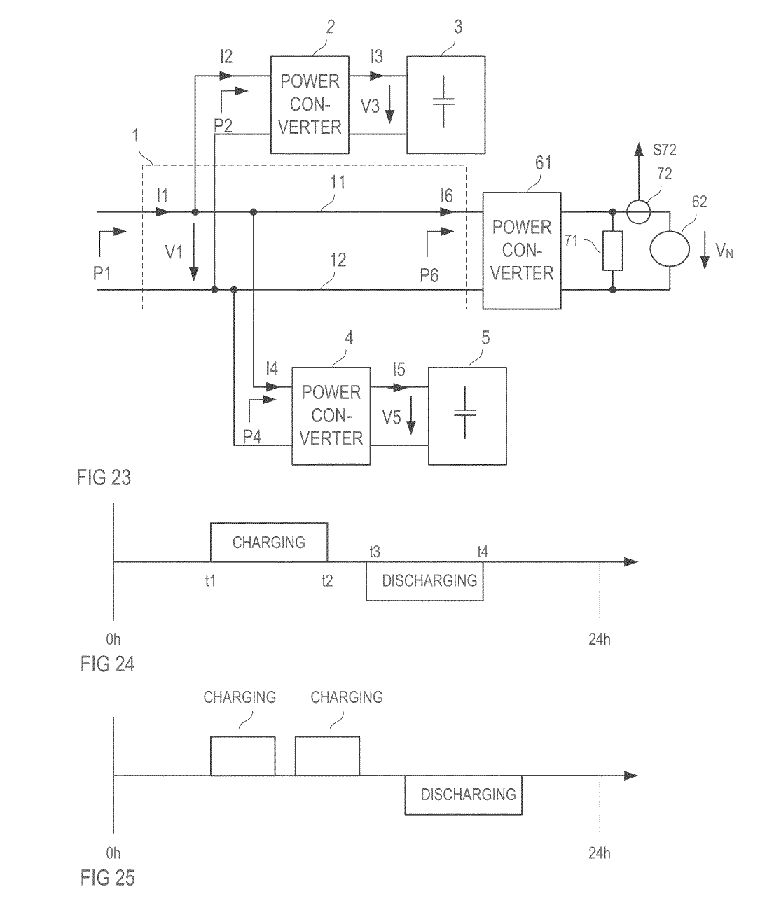

FIG. 23 illustrates a further embodiment of a power supply system. In this system, the power source 62 represents a power grid that provides an alternating reference supply voltage v_{N}. A load 71 is connected to the output of the power converter 61 and to the power grid 62 so that the load 71 can be supplied by both the power converter 61 and the power grid 62. The load 71 shown in FIG. 23 may represent one load or may represent a load arrangement with a plurality of loads. According to one embodiment, load 71 represents a plurality of loads in one household, in one building, or even in several buildings. In this system, there can be several load supply scenarios.

a. The load 71 may only receive power from the power converter 61, wherein the power converter 61 may or may not additionally supply power to the power grid.

b. The load 71 may receive power from the power converter 61 and the power grid 62.

c. The load 71 may only receive power from the power grid 62, wherein the power converter 61 may or may not additionally receive power from the power grid and supply power to the power supply bus 1. In case, the power converter may receive power from the power grid, the power converter 61 is configured to operate bidirectionally. That is, the power converter 61 is configured to either receive power, in particular DC power, from the power supply bus 1 and supply power, in particular AC power, to the load 71 and the power grid 62, respectively, or receive power, in particular AC power, from the power grid 62 and supply power, in particular DC power, to the power supply bus 1.

It may be desirable to keep the overall power consumption from the power grid 62, which is the power consumed by at least one of the load 71 and the power converter 61 from the power grid 62, as low as possible. According to one embodiment, a power meter 72 is coupled between the load 72 and the power grid 62. The power meter 72 is configured to provide a power meter signal that represents a power flow to or from the power grid. The power meter signal 72 represents the power level, that is the amount of power flowing to or from the power grid 62, and the direction of the power flow, that is whether the power grid 62 receives power from the power converter 61 or whether the power grid supplies power to at least one of the power converter 61 and the load 71.

According to one embodiment, at least one of the first power converter 2 and the second power converter 4 operates dependent on the power meter signal S72. According to one embodiment, the third power converter 61 is configured to control the supply voltage V1 on the power supply bus 1 by suitably adjusting the power P6 the third power converter 61 receives from the power supply bus 1. In this embodiment, the first power converter 2 charges or discharges the first charge storage device 3 in accordance with a predefined timing scheme, and the second power converter 4 charges or discharges the second charge storage device dependent on the power meter signal S72.

“Charging or discharging the first charge storage device 3 in accordance with a predefined timing scheme by the first power converter 2” may include at least one charging cycle within a predefined time period and a discharging cycle in a predefined time period. FIG. 24 illustrates one embodiment of a timing scheme that includes one charging cycle between times t1 and t2 and one discharging cycle between times t3 and t4 in 24 hours. According to one embodiment, in the charging cycle, the first power converter 2 is configured to charge the first charge storage device until the first charge storage device reaches a predefined charge stage. That is, the first power converter 2 may stop charging the first charge storage device 3 when the first charge storage device reaches a predefined charge state in the charging cycle. The “charge state” is defined by the amount of charge stored in the first charge storage device 3 relative to the maximum amount of charge that can be stored. For example, when the charge state is 80%, 80% of the maximum amount of charge has been stored in the charge storage device. According to one embodiment, in the discharging cycle, the first power converter 2 is configured to charge the first charge storage device until the first charge storage device reaches a predefined charge stage.

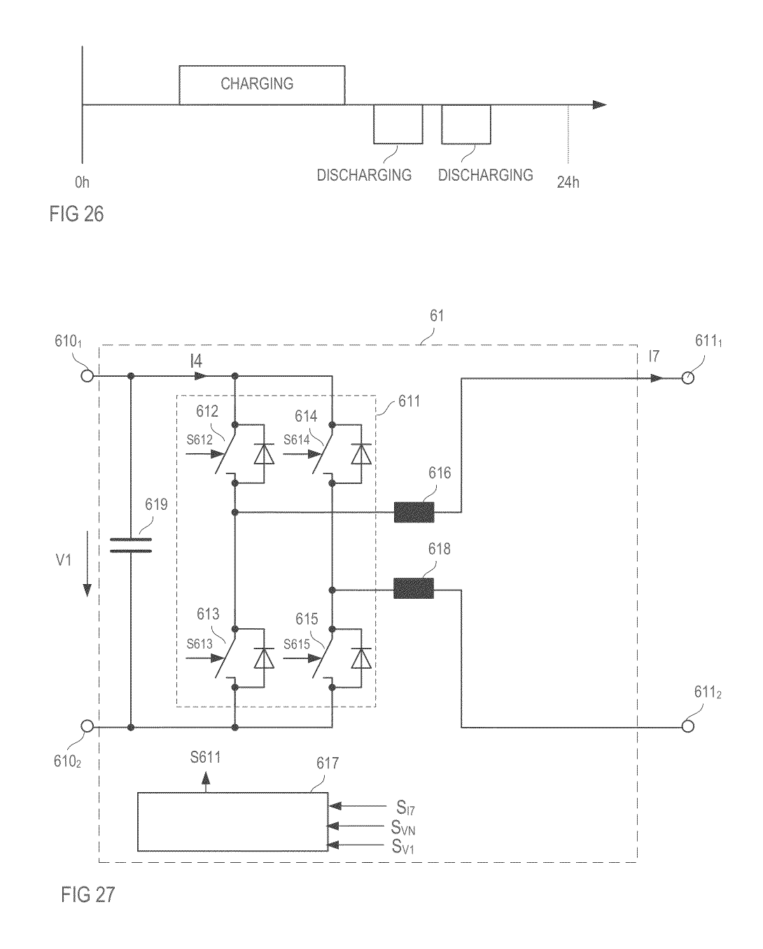

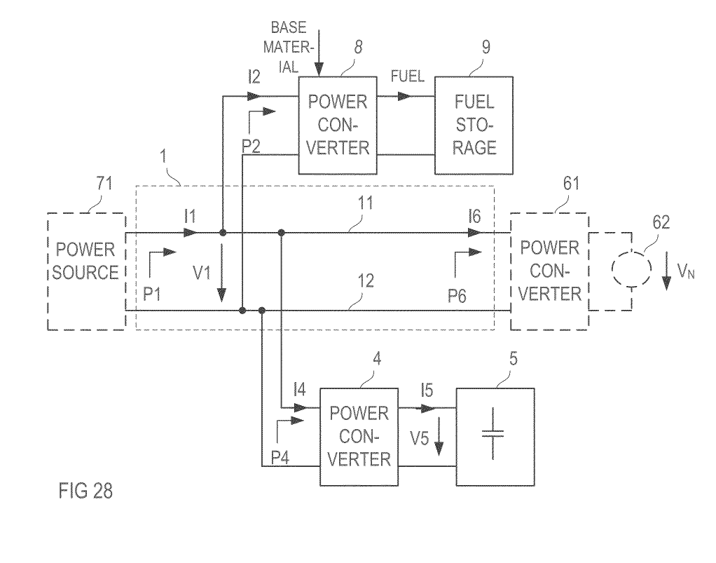

According to one embodiment, there are two or more timely spaced charging cycles in 24 hours, and according to one embodiment, there are two or more timely spaced discharging cycles in 24 hours. One embodiment of a timing scheme with two charging cycles and one discharging cycle is shown in FIG. 25. One embodiment of a timing scheme with one charging cycle and two discharging cycles is shown in FIG. 26. According to yet another embodiment, there are two or more charging cycles and two or more discharging cycles in 24 hours. The charging cycles and the discharging cycles may or may not be interleaved. When they are interleaved, there is at least one discharging cycle between two successive charging cycles, or there is at least one charging cycle between two successive discharging cycles.

The timing scheme for charging/discharging the first charge storage device 3 by the first power converter 2 may be such that the first charge storage device 3 is charged in those time periods in which the power P1 provided by the power source is higher than the power received by the third power converter 61, and that the first charge storage device 3 is discharged in those time periods in which the power P1 provided by the power source is lower than the power received by the third power converter 61. Those time periods may be set based on power production and power consumption scenarios observed in the past. Further, those time periods may vary based on at least one of the time of the year and the weather forecast. For example, the charging cycle may start later in winter than in summer, and the discharging cycle may start earlier in winter than in summer. For example, the charging cycle may be shorter on those days on which the forecast predicts clouds.

“Charging or discharging the second charge storage device dependent on the power meter signal S72” may include charging or discharging the second charge storage device 5 such that the power received by the load 71 from the power grid 62 is below a predefined power threshold. This is explained below.

The power received by the load 71 from the power grid 62 is indicated by the power meter signal S72. Referring to the explanation provided herein before, the third power converter 61 may be configured to control the bus voltage V1. In this case, an average power provided by the third power converter 61 to the load 71 and/or the power grid 62, respectively, is such that the bus voltage V1 is substantially constant. “The average power provided by the third power converter 61” is the average of the power provided by the third power converter over at least one period of the alternating grid voltage V_{N}. When the bus voltage V1 is substantially constant, the average power P6 received by the third power converter 61 corresponds to the input power P1 minus the power P2 received/provided by the first power converter 2, and the power P4 received/provided by the second power converter. That is:

P6=P1−P2−P4 (3),

where P2 is positive or negative dependent on whether the first power converter 2 receives power from the power supply bus (is in the charging mode) or supplies power to the power supply bus (is in the discharging mode). Equivalently, P4 is positive or negative dependent on whether the second power converter 2 receives power from the power supply bus (is in the charging mode) or supplies power to the power supply bus (is in the discharging mode).

The power level of the input power P1 is, for example, dependent on the weather conditions and the power received/provided by the first power converter 2 is dependent on the timing scheme that operates the first power converter in the charging mode, the discharging mode, or deactivates the first power converter 2. Thus, the power available on the power supply bus 1, like in the embodiments explained before, can be varied by adjusting the power P4 the second power converter 4 receives from the power supply bus 1 or supplies to the power supply bus. Through this, the power supplied by the third power converter 61 to the power grid can be adjusted. This is explained below.

For the purpose of explanation, it is assumed that the power meter signal S72 indicates that the power supplied to the power grid 62 increases above a predefined power threshold. This may occur when the power consumption of the load 71 increases and the power P6 received (and supplied) by the third power converter remains unchanged at first, or when the power available on the power supply bus 1 increases so that the third power converter 61 supplies more power to the load 71 and the power grid 62, respectively. The latter may occur when the input power P1 increases or when the first power converter either starts to receive less power from the power supply bus 1, or starts to supply more power to the power supply bus 1. As the power meter signal S72 indicates an increase of the power supplied to the power grid 62 to above the predefined threshold, the second power converter may increase the power level of the power P4 received from the power supply bus 1, so as to reduce the power available on the power supply bus 1. Equivalently, the second power converter 4 may reduce the power level of the power P4 received from the power supply bus, or may even supply power P4 to the power supply bus 1, when the power meter signal indicates that the power supplied to the power grid has fallen below the predefined threshold.

The power threshold may be positive or negative. In the first case, power is supplied to the power grid 62, in the second case, power is received from the power grid. If, for example, the predefined power threshold is substantially zero, substantially no power is supplied to the power grid 62, and substantially no power is received from the power grid.

According to one embodiment, the power threshold is dependent on the charge state of the second charge storage device 5. For example, the power threshold increases as the charge state of the second charge storage device increases, in order to allow more power to be supplied to the power grid 62 or to allow less power to be received from the power grid 62 as the charge state increases. Equivalently, the power threshold decreases as the charge state of the second charge storage device decrease, in order to allow less power to be supplied to the power grid 62 or to allow more power to be received from the power grid 62 as the charge state decreases. The power threshold may increase/decrease continuously as the charge state increases/decrease or may increase/decrease stepwise.

FIG. 27 illustrates one embodiment of a third power converter 61 that is configured to receive the (DC) bus voltage V1 and to supply a current I7 to the load 71 and the power grid 62, respectively. A circuit of this type is well known in the art and is only briefly explained in the following. Similar circuits known in the art may be used instead.

In this power converter 61, the current I7 may be in phase with the grid voltage V_{N} or there may be a predefined phase shift between the current and the grid voltage V_{N}. Referring to FIG. 27, the third power converter 61 includes a bridge circuit 611 with two half-bridges each including a high-side switch 612, 614 and a low-side switch 613, 615, and each connected between input nodes 610₁, 610₂ of the third power converter 61. The input nodes 610₁, 610₂ are connected to the power supply bus 1 for receiving the bus voltage. An output node of a first half-bridge circuit 612, 613 is coupled to a first output node 611₁ of the third power converter 61, and an output node of a second half-bridge 614, 615 is coupled to a second output node 611₂ of the third power converter 61. Each of the switches may be implemented like the switches disclosed in context with FIGS. 19 and 20 above.

At least one inductive storage element, such as a choke, is coupled between the output node of one of the first and the second half-bridge the respective first and second output node 611₁, 611₂. In the embodiment shown in FIG. 27, a first inductive storage element 616 is connected between the first half-bridge 612, 613 and the first output node 611₁, and a second inductive storage element 618 is connected between the second half-bridge 614, 615 and the second output node 611₂. However, this is only an example, one of these inductive storage elements would be sufficient.

Referring to FIG. 27, a control circuit drives the switches 612-615 based on a grid voltage signal S_{VN} representing the grid voltage, an output current signal S_{I7} representing the output current, and a bus voltage signal representing the bus voltage V1. In FIG. 27, reference character S611 denotes the plurality of drive signals S612-S615 the bridge circuit 611 receives from the control circuit. According to one embodiment, the output current I7 is an alternating current with a, for example, sinusoidal waveform. According to one embodiment, during a positive half wave of the current I7, the control circuit operates the high-side switch 612 and the low-side switch 613 of the first half-bridge 612, 613 in a PWM fashion such that only one of these switches is switched on at the same time. The high-side switch 614 of the second half-bridge 614, 615 is permanently off, and the low-side switch 615 of the second half-bridge 614, 615 is permanently on in this operation mode. During a negative half wave of the current I7, the control circuit operates the high-side switch 614 and the low-side switch 615 of the second half-bridge 614, 615 in a PWM fashion such that only one of these switches is switched on at the same time. The low-side switch 613 of the first half-bridge 612, 613 is permanently on, and the high-side switch 612 of the first half-bridge 612, 613 is permanently off in this operation mode. The control circuit 617 is configured to adjust the duty cycle in the PWM mode of the first half-bridge 612, 613 and in the PWM mode of the second half-bridge 614, 615 such that the output current I7 is in phase with the grid voltage V_{N} (or that there is a predefined phase difference) and that a voltage level of the bus voltage V1 is set to a predefined threshold level.

The first power converter 2 and the second power converter 4 have been described as electrical power converters herein before. That is, these power converters 2 convert electrical power into electrical power. However, this is only an example. According to another embodiment, at least one of the first and second power converters 2, 4, such as the first power converter, is configured to use electrical power to synthesize fuel, such as hydrogen or methane, and to use the fuel to generate electrical power.

FIG. 24 illustrates one embodiment of a power supply system in which the first power converter 9 is configured to either receive electrical power from the power supply bus 1 and to generate fuel using the electrical power P2 and base material, or to receive fuel and to supply electrical power P2 to the power supply bus 1 by burning the fuel. The fuel may be hydrogen, in this case the base material is water. The fuel is stored in and received from a storage arrangement 9, such as a fuel tank. Unlike an electrical power converter, the power converter 8 internally may include to separate converter, namely one converter for synthesizing the fuel, such as an electrolysis apparatus, and one converter for burning the fuel, such as a fuel cell.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

Spatially relative terms such as “under,” “below,” “lower,” “over,” “upper” and the like, are used for ease of description to explain the positioning of one element relative to a second element. These terms are intended to encompass different orientations of the device in addition to different orientations than those depicted in the figures. Further, terms such as “first,” “second” and the like, are also used to describe various elements, regions, sections, etc. and are also not intended to be limiting Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A system comprising:
a power supply bus configured to be coupled to a power source;
a first power converter coupled between the power supply bus and a first charge storage device; and
a second power converter coupled between the power supply bus and a second charge storage device;
wherein in a first operation mode of the system the first power converter is configured to only operate in one of a charging mode in which it charges the first charge storage device and a discharging mode in which it discharges the first charge storage device, and the second power converter is configured to operate either in a charging mode in which it charges the second charge storage device, or in a discharging mode in which it discharges the second charge storage device.

2. The system of claim 1, wherein the system is configured to enter the first operation mode less than ten times in one day.

3. The system of claim 1, wherein, in the first operation mode, the second power converter is configured to control a bus voltage available on the power supply bus by one of charging and discharging the second storage device.

4. The system of claim 3, wherein, in the first operation mode, the second power converter is configured
to enter the discharging mode when the bus voltage falls below a first voltage threshold, and
to enter the charging mode when the bus voltage falls below a first voltage threshold, and
to enter the discharging mode when the bus voltage rises above a second voltage threshold higher than the first voltage threshold.

5. The system of claim 1, wherein in a second operation mode of the system the first power converter is configured to only operate in the discharging mode, and the second power converter is configured to operate either in the charging mode, or in the discharging mode.

6. The system of claim 5, wherein the system is configured to enter the second operation mode less than five times in one day.

7. The system of claim 5, wherein, in the second operation mode, the second power converter is configured to control a bus voltage available on the power supply bus by one of charging and discharging the second storage device.

8. The system of claim 7, wherein, in the second operation mode, the second power converter is configured
to enter the charging mode when the bus voltage rises above a third voltage threshold, and
to enter the discharging mode when the bus voltage falls below a fourth voltage threshold lower than the third voltage threshold.

9. The system of claim 1, wherein in a third operation mode of the system the first power converter is deactivated, and the second power converter is configured to operate either in the charging mode, or in the discharging mode.

10. The system of claim 9, wherein, in the first operation mode, the second power converter is configured to control a bus voltage available on the power supply bus by one of charging and discharging the second storage device.

11. The system of claim 1, wherein the system is configured to enter the first operation mode dependent on at least one parameter selected from the group consisting of:
the time; and
a voltage available on the power supply bus.

12. The system of claim 1, wherein the first power converter, in the first operation mode is configured to charge the first charge storage device either in a constant current mode, or in a constant voltage mode.

13. The system of claim 1, further comprising:
a third power converter coupled to the power supply bus and configured to be coupled to a load and a power grid; and
a power meter configured to be coupled between the third power converter and the power grid and configured to provide a power meter signal.

14. The system of claim 13, wherein in the first operation mode,
the third power converter is configured to control a bus voltage available on the power supply bus, and
the second power converter is configured to one of charge and discharge the second charge storage device based on the power meter signal.

15. The system of claim 14, wherein the second power converter is further configured to one of charge and discharge the second charge storage device based on a power threshold level.

16. The system of claim 15, wherein the power threshold level is based on a charge state of the second charge storage device.

17. The system of claim 14, wherein the system is configured to enter the first operation mode based on a predefined timing scheme.

18. The system of claim 1,
wherein the first power converter comprises a cascade with a plurality of converter stages each comprising an input and an output,
wherein the first charge storage device comprises a plurality of storage cells, with each storage cells coupled the output of one of the plurality of converter stages.

19. The system of claim 1, wherein the first charge storage device is a first type charge storage device, and the second charge storage device is a second type charge storage device different from the first type.

20. The system of claim 19, wherein the first charge storage device has a lower power density than the second charge storage device.

21. The system of claim 19, wherein the first charge storage device comprises at least one accumulator selected from the group consisting of:
a lead acid accumulator; and
a lithium-ion accumulator.

22. The system of claim 14, wherein the second charge storage device comprises a super capacitor.

23. A method comprising:
operating in a first operation mode of a system a first power converter coupled to a power supply bus only in one of a charging mode in which it charges a first charge storage device and a discharging mode in which it discharges the first charge storage device,
and operating in the first operation mode a second power converter coupled to the power supply bus either in a charging mode in which it charges a second charge storage device, or in a discharging mode in which it discharges the second charge storage device.
